(19) United States
(12) Patent Application Publication
(10) Pub. No.: US 2008/0247403 A1
(43) Pub. Date: Oct. 9, 2008

(54) NETWORK BRIDGE APPARATUS AND COMMUNICATION METHOD THEREOF

(75) Inventors: Young-kwang SEO, Seoul (KR); Hun-gu LEE, Seoul (KR); Hyun-chin KIM, Seongnam-si (KR); Keun-joo PARK, Yongin-si (KR); Yeong-bae YEO, Daegu (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/939,602

(22) Filed: Nov. 14, 2007

(30) Foreign Application Priority Data
Apr. 3, 2007 (KR) 10-2007-0033020

(51) Int. Cl. H04L 12/66

(52) U.S. Cl. 370/401

(57) ABSTRACT

A network bridge apparatus and a communication method using the network bridge apparatus are provided. In the network bridge apparatus, a storage stores first attribute information which is provided by a first device of a first cluster for communication, an external communicator transmits the stored first attribute information to a second cluster and receives second attribute information which is provided by a second device of the second cluster for communication, from the second cluster, and a controller recognizes a service provided by the second device from the received second attribute information, creates a virtual device corresponding to the second device by changing the received second attribute information, and maps the changed second attribute information to the received second attribute information.

### CROSS-REFERENCE TO RELATED APPLICATIONS

This application claims priority from Korean Patent Application No. 10-2007-0033020, filed on Apr. 3, 2007, in the Korean Intellectual Property Office, the entire disclosure of which is incorporated herein by reference.

### BACKGROUND OF THE INVENTION

1. Field of the Invention

Apparatuses and methods consistent with the present invention relate to a network bridge and communication using the network bridge, more particularly, to a network bridge for providing a bridge function through search of services of devices positioned in a foreign cluster, and communication using the network bridge apparatus.

2. Description of the Related Art

The Institute of Electrical and Electronics Engineers (IEEE) 1394, which is a technology supporting a home network, enables communication between devices through an IEEE 1394 bus. The IEEE 1394 bus allows maximum 64 devices to participate in communication through the IEEE 1394 bus, and supports a maximum distance of 4.5 m between two devices. Due to the short maximum supportable distance of 4.5 m, a bridge technique is required to support room-to-room services, that is, to support connection between rooms. It is the IEEE 1394.1 bridge standard that is recently defined to meet the need (see IEEE Standard 1394.1-2004, Standard for High Performance Serial Bus Bridges).

However, up to now, an IEEE 1394 chip for functioning as an IEEE 1394.1 bridge is defined only in the specification and its actual implementation has not been realized and commercialized yet. Thus, to utilize the IEEE 1394.1 bridge in an IEEE 1394 network, development of an IEEE 1394 bridge chip for performing the 1394.1 bridge function is required.

According to the IEEE 1394 specification and the IEEE 1394.1 bridge specification, the IEEE 1394.1 bridge does not support compatibility with an IEEE 1394 device. Hence, in an IEEE 1394 home network using an IEEE 1394.1 bridge, an IEEE 1394 device, for example, an IEEE 1394.2000 device cannot normally perform the home networking without an IEEE 1394.1 bridge awareness function.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention has been provided to address the above-mentioned and/or other problems and disadvantages and an aspect of the present invention provides a network bridge apparatus which provides a bridge function based on an IEEE 1394 chip which is actually developed and commercialized, and which supports compatibility with IEEE 1394-2000 devices, and a communication method of the network bridge apparatus.

According to an aspect of the present invention, there is provided a network bridge apparatus including a storage which stores first attribute information which is provided by a first device belonging to a first cluster for communication; an external communicator which transmits the stored first attribute information to a second cluster and receives second attribute information which is provided by a second device belonging to the second cluster for communication, from the second cluster; and a controller which recognizes a service provided by the second device from the received second attribute information, creates a virtual device corresponding to the second device by changing the received second attribute information, and maps the changed second attribute information to the received second attribute information.

When a service of the virtual device is requested by the first device, the controller may inform the second cluster of a request for a remote connection to the second device corresponding to the virtual device using the changed second attribute information and the received second attribute information.

The controller may notify the creation of the virtual device to the first device, wherein the first device recognizes as if the virtual device exists in the first cluster.

The controller may generate the changed second attribute information by changing a communication port number of the second device and a plug of the second device required for transport stream transmission included in the received second attribute information.

The first device, after requesting the remote connection with the virtual device, may perform an IEEE 1394 Communication Management Procedure (CMP) by referring to the changed plug information of the second device.

The network bridge apparatus may further include an internal communicator which outputs the transport stream received from the second device to the first device through the changed plug of the second device.

The controller may change the received second attribute information to act as a proxy for the second device, and create a virtual device corresponding to the changed second attribute information.

The second cluster may include a bridge module which transmits the second attribute information to the external communicator, recognizes a service provided by the first device by receiving the first attribute information through the external communicator, creates a virtual device corresponding to the first device by changing the received first attribute information, and maps the changed first attribute information to the received first attribute information.

The bridge module may perform the IEEE 1394 CMP by referring to plug information of the second device when a remote connection with the second device is requested from the first device, receive a transport stream corresponding to the service requested by the first device and output from the second device through a plug of the second device, and forward the received transport stream to the external communicator.

The bridge module may receive the transport stream from the plug of the second device through a changed plug of the first device, wherein the changed plug is contained in the changed first attribute information.

The bridge module may establish the connection to the second device and receives the transport stream by performing the IEEE 1394 CMP based on the plug information of the second device.

The bridge module may change the received first attribute information to act as the proxy for the first device, create a virtual device corresponding to the changed first attribute information, and inform the second device of the virtual device creation.

The plug for transmitting and receiving the transport stream of the first attribute information and the second attribute information may be a temporary plug which is set to use a plug currently not in an idle mode among a plurality of plugs.

A plurality of the first devices and a plurality of the second devices may be connected to the network bridge apparatus.

The first cluster and the second cluster may communicate according to an IEEE 1394 specification.

The first device, the second device, and the controller may operate based on a High definition Audio-video Network Alliance (HANA) application. The first device and the second device may provide the first attribute information and the second attribute information, respectively, using a Consumer Electronics Association (CEA)-2027 file of the HANA application after an initialization phase according to the IEEE 1394 specification.

The second cluster may gather a CEA-2027 file of the second device including the second attribute information, from the second device and transmit the gathered file to the external communicator. The controller may create a virtual device corresponding to the second device by adding the second attribute information of the CEA-2027 file of the second device to a CEA-2027 file of the controller.

The first device, the second device, and the controller may operate based on an Audio/Video Control (AV/C) application. The first cluster may transmit the first attribute information to the second cluster in an initialization phase according to the IEEE 1394 specification, The second cluster may transmit the second attribute information to the external communicator in the initialization phase according to the IEEE 1394 specification.

Each of the first attribute information and the second attribute information may contain subunit information which includes a subunit type and a subunit IDentifier (ID) for distinguishing the first device and the second device.

The first cluster and the second cluster may communicate with each other using at least one of wired communication using a coaxial cable, wired communication using Power Line Communication (PLC), wired communication using an Ethernet cable, and wireless communication.

According to the aspect of the present invention, a communication method of a network bridge apparatus includes storing first attribute information which is provided by a first device belonging to a first cluster for communication; transmitting the stored first attribute information to a second cluster and receiving second attribute information which is provided by a second device belonging to the second cluster for communication, from the second cluster; recognizing a service of the second device from the received second attribute information, and creating a virtual device corresponding to the second device by changing the received second attribute information; and mapping the changed second attribute information to the received second attribute information.

The communication method may further include receiving a request of the first device for a service provided by the virtual device; and informing the second cluster of a request for a remote connection with the second device corresponding to the virtual device using the changed second attribute information and the received second attribute information.

The communication method may further include notifying the created virtual device creation to the first device, wherein the first device recognizes as if the virtual device exists in the first cluster.

The creating the virtual device may comprise generating the changed second attribute information by changing a communication port number of the second device and a plug of the second device required for transport stream transmission, included in the received second attribute information.

The communication method may further include outputting a transport stream received from the second device to the first device through the changed plug of the second device.

The creating operation the virtual device may comprise changing the received second attribute information to act as a proxy for the second device, and create the virtual device corresponding to the changed second attribute information.

The second cluster may transmit the second attribute information to the first cluster, recognize a service provided by the first device by receiving the first attribute information received through the first cluster and create a virtual device corresponding to the first device in a bridge module by changing the received first attribute information, and map the changed first attribute information to the received first attribute information.

The communication method may further include performing the IEEE 1394 CMP by referring to a plug of the second device when a service provided by the second device is requested from the first device, receiving the transport stream output through the plug of the second device from the second device, and receiving the transport stream corresponding to the service requested by the first device and from the plug of the second device through the changed plug of the first device, the changed plug contained in the changed first attribute information; and transmitting the received transport stream to the first cluster.

The communication method may further include establishing the connection to the second device by performing the IEEE 1394 CMP according to the plug information of the second device.

In creating the virtual device, the bridge module may change the received first attribute information to act as a proxy for the first device and create the virtual device corresponding to the changed first attribute information.

### BRIEF DESCRIPTION OF THE DRAWING FIGURES

Above and other aspects of the present invention will become apparent and more readily appreciated from the following description of the exemplary embodiments, taken in conjunction with the accompany drawings, in which:

FIG. 1 illustrates an exemplary IEEE 1394 network to which a network bridge apparatus according to an exemplary embodiment of the present invention is applied;

FIG. 2 is a simplified block diagram of a first bridge apparatus, which is the network bridge apparatus of FIG. 1, according to an exemplary embodiment of the present invention;

FIG. 3 is a block diagram of a first bridge apparatus and a second bridge apparatus, which are the network bridge apparatuses of FIG. 1, according to an exemplary embodiment of the present invention;

FIG. 4 illustrates part of layers of the first bridge apparatus, the first device, the second bridge apparatus, and the second device of FIG. 1;

FIG. 5 illustrates a general CEA-2027 file format according to an exemplary embodiment of the present invention;

FIG. 6A illustrates first attribute information of the first device of FIG. 1, according to an exemplary embodiment of the present invention;

FIG. 6B illustrates second attribute information of the second device, according to an exemplary embodiment of the present invention;

FIG. 7A illustrates modified second attribute information generated by the first controller of FIG. 3, according to an exemplary embodiment of the present invention;

FIG. 7B illustrates a first routing table generated by the first controller, according to an exemplary embodiment of the present invention;

FIG. 7C illustrates a first local table generated by the first controller, according to an exemplary embodiment of the present invention;

FIG. 8A illustrates modified first attribute information generated by the second controller of FIG. 3, according to an exemplary embodiment of the present invention;

FIG. 8B illustrates a second routing table generated by the second controller, according to an exemplary embodiment of the present invention;

FIG. 8C illustrates a second local table generated by the second controller, according to an exemplary embodiment of the present invention;

FIG. 9 illustrates a table of information used for a digital television (DTV) to request icon transmission to the first bridge apparatus, according to an exemplary embodiment of the present invention;

FIG. 10 illustrates a table of information used for the second bridge apparatus to request icon transmission to a first storage medium, according to an exemplary embodiment of the present invention;

FIG. 11 illustrates actual service request after icons of the second devices are displayed on the DTV, according to an exemplary embodiment of the present invention;

FIG. 12 is a simplified table of information used for the DTV to request a transport stream to the first storage medium and to receive the transport stream from the first storage medium, according to an exemplary embodiment of the present invention;

FIG. 13 illustrates operations before a transport stream is actually transmitted and received in the communications over the IEEE 1394 network of FIG. 1, according to an exemplary embodiment of the present invention;

FIG. 14 illustrates the transport stream reception at the DTV of the first cluster from the first storage medium of the second cluster after the operations of FIG. 13 are carried out, according to an exemplary embodiment of the present invention;

FIG. 15 illustrates an IEEE 1394 network to which a network bridge apparatus is applied according to further exemplary embodiment of the present invention;

FIG. 16A illustrates a third local table generated by a third controller, according to an exemplary embodiment of the present invention;

FIG. 16B illustrates a fourth local table generated by a fourth controller, according to an exemplary embodiment of the present invention;

FIG. 17A illustrates a third routing table generated by the third controller, according to an exemplary embodiment of the present invention; and

FIG. 17B illustrates a fourth routing table generated by the fourth controller, according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

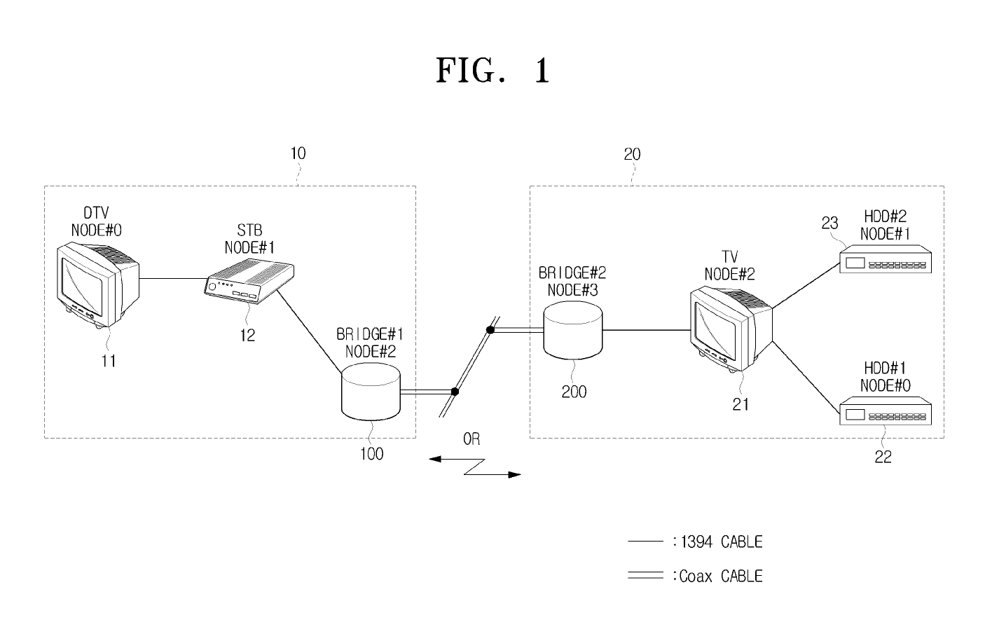

FIG. 1 illustrates an IEEE 1394 network to which a network bridge apparatus according to an exemplary embodiment of the present invention is applied.

The IEEE 1394 (hereinafter, referred to as “1394”) network of FIG. 1 includes a first cluster 10 and a second cluster 20.

The first cluster 10 is a network group formed by interconnecting a plurality of first devices 11 and 12 using a first bridge apparatus 100. The second cluster 20 is a network group formed by interconnecting a plurality of second devices 21, 22 and 23 using a second bridge apparatus 200.

The first bridge apparatus 100 is connected to the first devices 11 and 12 using 1394 cables. Hereafter, the first devices 11 and 12 are a digital television (DTV) 11 and a set-top box (STB) 12 by way of example. The second bridge apparatus 200 is connected to the second devices 21, 22 and 23 using 1394 cables. Hereafter, the second devices 21, 22 and 23 are a TV 21, a first storage medium 22, which is a hard disk drive (HDD#1), and a second storage medium 23 (HDD#2) by way of example.

The first and second devices 11, 12, 21, 22 and 23, the first and second bridge apparatuses 100 and 200, and the 1394 cables support the 1394 standard. The first bridge apparatus 100 and the second bridge apparatus 200 communicate with each other using wired communication, Power Line Communication (PLC), wireless LAN communication, or CAT-5 Ethernet communication using coaxial cables.

When the 1394 network is applied to a home network, the first cluster 10 and the second cluster 20 can be separate spaces such as rooms and sitting rooms in home. The 1394 network can provide room-to-room services. A room-to-room service enables a device of the first cluster 10 to communicate with a device of the second cluster 20 and share data and contents.

For example, the first and second devices 11, 12, 21, 22 and 23 may be electronic products such as monitor, TV, VCR, refrigerator, camcorder, STB, digital video disk (DVD) player, personal computer (PC), digital camera, printer, and fax machine.

The 1394 network is not limited to the home network but applicable to intranets or networks established between buildings. The number of clusters and the number of devices in FIG. 1 are not limited. Other components of the first and second clusters 10 and 20 are omitted in the drawing but only essential components are depicted for the understanding of the present invention. The number of the first devices in the first cluster may be the same as or different from the number of the second devices in the second cluster 20.

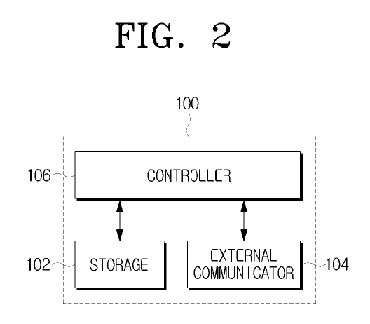

FIG. 2 is a simplified block diagram of the first bridge apparatus, which is a network bridge apparatus, of FIG. 1, according to an exemplary embodiment of the present invention.

In FIG. 2, the first bridge apparatus 100 includes a storage 102, an external communicator 104, and a controller 106.

The storage 102 stores first attribute information provided by the first devices 11 and 12, that is, the DTV 11 and the STB 12 of the first cluster 10, for communication.

The external communicator 104 transmits the first attribute information stored to the storage 102 to the second cluster 20, and receives from the second cluster 20 second attribute information provided by the second devices 21, 22 and 23 of the second cluster 20 for communication. The external communicator 104 can be a various communication device such as a coaxial modem using a coaxial cable, a wireless communication modem, and a PLC modem supporting the PLC.

The controller 106 recognizes services provided from the second devices 21, 22 and 23 by analyzing the second attribute information received from the second cluster 20, and creates virtual devices corresponding to the second devices 21, 22 and 23. To make the first devices 11 and 12 recognize the existence of the virtual devices in the first cluster 10, the controller 106 notifies the first devices 11 and 12 of the new device connections.

The virtual devices corresponding to the TV 21, the first storage medium 22, and the second storage medium 23 are logical devices. The controller 106 controls to store changed second attribute information to the storage 102 as a lookup table (hereafter, referred to as a routing table) by mapping the changed second attribute information to the received second attribute information.

If the controller 106 works based on a High definition Audio-video Network Alliance (HANA) application, the first attribute information is various information provided by Consumer Electronics Association (CEA)-2027 (hereinafter “2027”) file of the HANA application and contains information on a communication port required for an Internet Protocol (IP) communication, a plug number required for transport stream transmission, and so forth. If the controller 106 works based on an Audio/Video Control (AV/C) application, the first attribute information contains a plug number, required to transmit a transport stream, and a subunit type and a subunit identifier (ID), required to distinguish devices, among various information provided by the AV/C application.

As mentioned above, the first bridge apparatus 100 creates the virtual devices corresponding to the TV 21, the first storage medium 22, and the second storage medium 23 by changing the details (e.g., port number) of the second attribute information received from the second cluster 20, and acts as a proxy for the second devices 21, 22 and 23 as if the devices belonging to the second cluster 20 are actually present in the first bridge apparatus 100.

Thus, the first devices 11 and 12 recognize that the TV 21, the first storage medium 22, and the second storage medium 23 actually exist in the first cluster 10, and requests services provided from the TV 21, the first storage medium 22, and the second storage medium 23 based on the 1394 standard. Thus, by using a chip developed based on the 1394 standard, it is possible to use a service of a device positioned in another cluster.

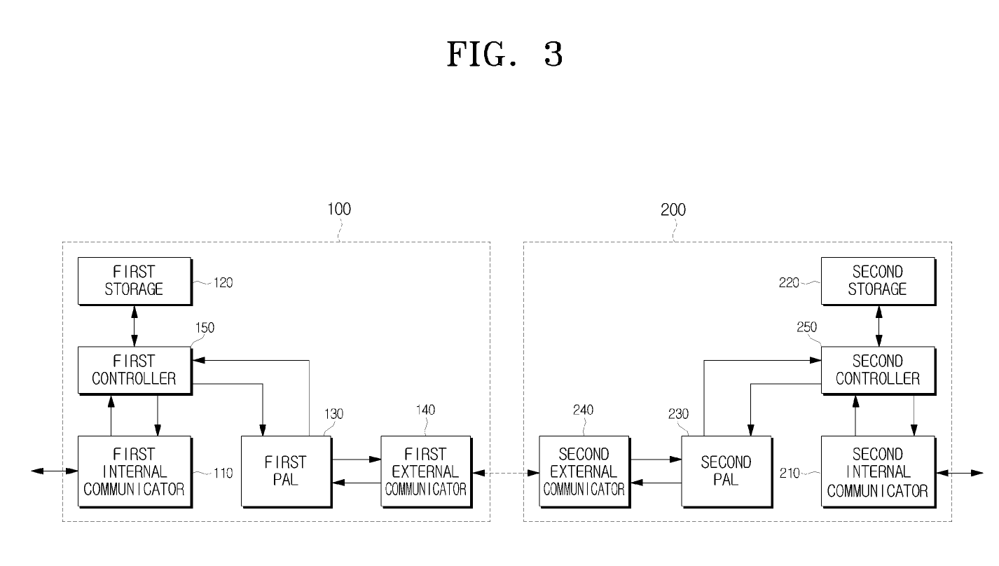

FIG. 3 is a block diagram of a first bridge apparatus and a second bridge apparatus, which are the network bridge apparatuses of FIG. 1, according to another exemplary embodiment of the present invention.

Referring to FIGS. 1 and 3, the first bridge apparatus 100 includes a first internal communicator 110, a first storage 120, a first Protocol Adaptation Layer (PAL) 130, a first external communicator 140, and a first controller 150.

The first bridge apparatus 100 acts as the bridge between the first devices 11 and 12 of the first cluster 10 and the second devices 21, 22 and 23 of the second cluster 20 by communicating with the second bridge apparatus 200 of the second cluster 20 or other bridge apparatuses (not shown) of other clusters in a wired or wireless manner.

The first internal communicator 110 is a 1394 Physical Layer (PHY) controller for providing a 1394 interface between the DTV 11 and the STB 12, and the first bridge apparatus 100. The first internal communicator 110 transmits and receives 1394 signals to and from the first devices 11 and 12 using a 1394 cable; that is, using a 1394 bus and a 1394 protocol. Particularly, the first internal communicator 110 collects the first attribute information provided from the DTV 11 and the STB 12 for the communication.

The first storage 120 stores the first attribute information provided from the DTV 11 and the STB 12. The first storage 120 also stores second attribute information provided by the second devices 21, 22 and 23 for their communication, from the second bridge apparatus 200 of the second cluster 20.

The first PAL 130 performs protocol adaptation between the 1394 protocol and the protocol used at the first external communicator 140.

The first external communicator 140 communicates with the second cluster 20 or other clusters using one of wired communication using a coaxial cable, communication using PLC, wireless LAN communication, and wired communication using an Ethernet cable. For instance, when the first bridge apparatus 100 and the second bridge apparatus 200 are connected through a coaxial cable, the first external communicator 140 can be a coaxial cable modem. When using wireless communication, the first external communicator 140 can be a wireless LAN card.

The first external communicator 140 can employ an Ultra Wide Band (UWB) transmission technique in wireless environment (see IEEE Std. 802.15.3a). The 1394TA Wireless Working Group is working on the wireless UWB communication using a coaxial cable, and using the coaxial cable modem as well.

Meanwhile, the second bridge apparatus 200 of the second cluster 20 includes a second internal communicator 210, a first storage 220, a second PAL 230, a second external communicator 240, and a second controller 250.

The second internal communicator 210 is a 1394 PHY controller for providing a 1394 interface between the TV 21, the first storage medium 22, the second storage medium 23, and the second bridge apparatus 200. The second internal communicator 210 collects the second attribute information provided from the TV 21, the first storage medium 22, and the second storage medium 23 for their communication.

The second storage 220 stores the second attribute information provided from the TV 21, the first storage medium 22, and the second storage medium 23, and stores the first attribute information received from the first bridge apparatus 100.

The second PAL 230 performs the protocol adaptation between the 1394 protocol and the protocol used at the second external communicator 240 (e.g., UWB protocol).

The second external communicator 240 communicates with the first cluster 10 or other clusters in a wired or a wireless communication.

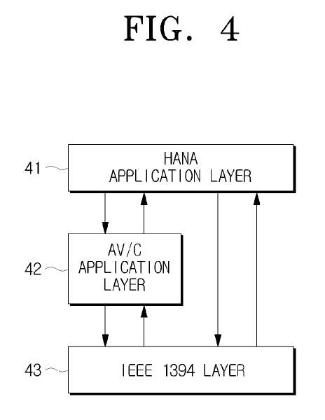

FIG. 4 illustrates part of layers of the first bridge apparatus 100, the first devices 11 and 12, the second bridge apparatus 200, and the second devices 21, 22 and 23 of FIG. 1.

In FIG. 4, for example, the first bridge apparatus 100, the first devices 11 and 12, the second bridge apparatus 200, and the second devices 21, 22 and 23 communicate to one another using the 1394 protocol by a 1394 layer 43 and provide their functions by a HANA application of a HANA application layer 41 and an AV/C application of an AV/C application layer 42.

That is, the first bridge apparatus 100, the first devices 11 and 12, the second bridge apparatus 200, and the second devices 21, 22 and 23 are HANA devices. The HANA application supports a user interface for the service, whereas the AV/C application does not support the user interface.

The HANA application has a 2027 file containing detailed information of a device supporting the 1394 standard.

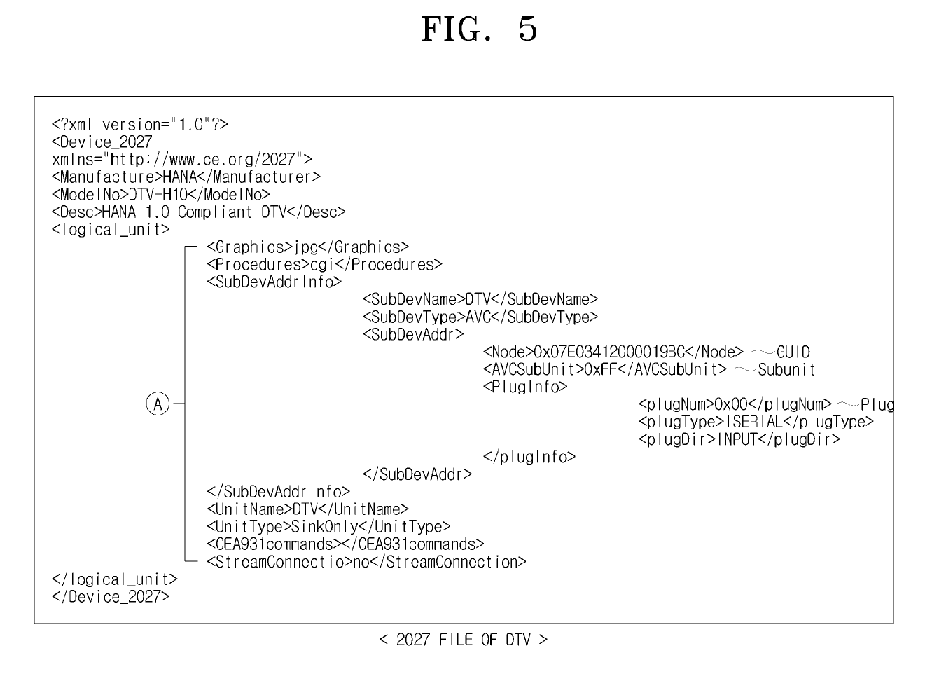

FIG. 5 illustrates a general 2027 file format. FIG. 5 shows a DTV 2027 file example of the HANA Design Guideline ver. 1.0.

In FIG. 5, the 2027 file is written in an XML format for example, and contains attribute information such as a port number, Global Unique IDentifier (GUID), Audio Video Control (AV/C) subunit information, and input/output plugs.

The port number is required for an Hypertext Transfer Protocol (HTTP) communication, the GUID is a unique ID of a 1394 device, AV/C subunit information indicates a category of the device (e.g., monitor, storage medium, printer, etc.), the input plug is a plug number required to input a transport stream, and the output plug is a plug number required to output a transport stream.

Referring back to FIG. 3, when a new 1394 device is connected to the first cluster 10, the existing 1394 device is deleted, or the power is on, the first internal communicator 110 performs a 1394 initialization. For example, node self IDs are allocated to the first devices 11 and 12 and the first bridge apparatus 100. Likewise, the second internal communicator 210 performs a 1394 initialization to allocate node self IDs to the second devices 21, 22 and 23 and the second bridge apparatus 200.

Referring back to FIG. 1, through a 1394 initialization, NODE#0 is assigned to the DTV 11, NODE#1 is assigned to the STB 12, NODE#2 is assigned to the first bridge apparatus 100, NODE#2 is assigned to the TV 21, NODE#0 is assigned to the first storage medium 22, NODE#1 is assigned to the second storage medium 23, and NODE#3 is assigned to the second bridge apparatus 200.

Since the device with the HANA application installed communicates using an IP address, the DTV 11, the STB 12, the TV 21, the first storage medium 22, and the second storage medium 23 are assigned respective IP addresses according to the Home Network Communication Protocol (HNCP), the Dynamic Host Configuration Protocol (DHCP), and the Zero-Configuration. The assigned IP addresses can be used for the HANA application to distinguish the devices.

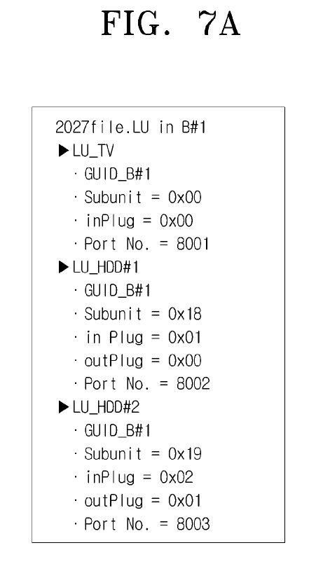

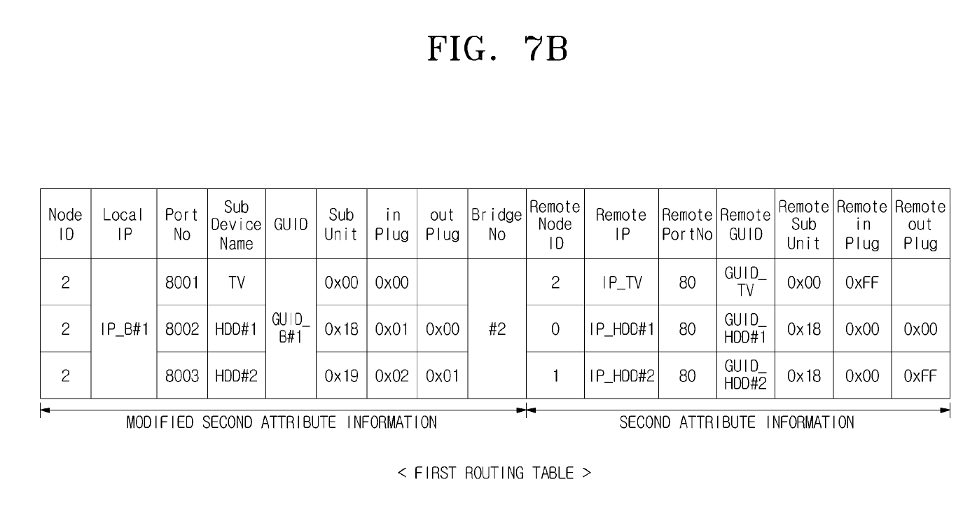

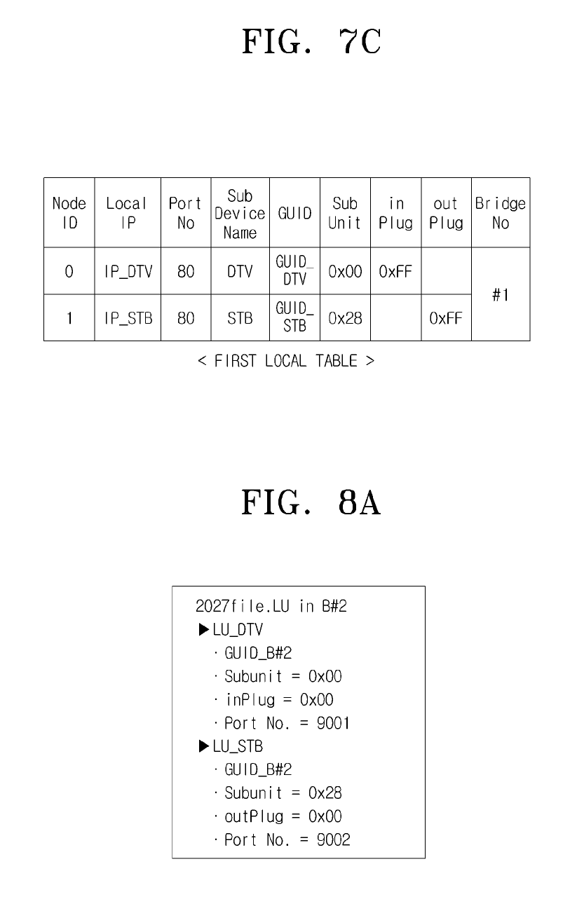

When the respective IP addresses are assigned, the first controller 150 controls the first internal communicator 110 to request 2027 file transmission from the DTV 11 and the STB 12 of the first cluster 10. Hence, the first internal communicator 110 collects a 2027 file provided from the DTV 11 and a 2027 file provided from the STB 12, that is, collects the first attribute information. The collected first attribute information of the DTV 11 and the STB 12 are stored to the first storage 120 in a format as shown in FIG. 7C under the control of the first controller 150.

The second controller 250 controls to collect the second attribute information from the second devices 21, 22 and 23 of the second cluster 20, and store the second attribute information to the second storage 220.

The first controller 150 and the second controller 250 exchange and share the collected first attribute information and second attribute information. In specific, the first controller 150 controls the first PAL 130 and the first external communicator 140 to transmit the first attribute information to the second bridge apparatus 200, and the second controller 250 controls the second PAL 230 and the second external communicator 240 to transmit the second attribute information to the first bridge apparatus 100.

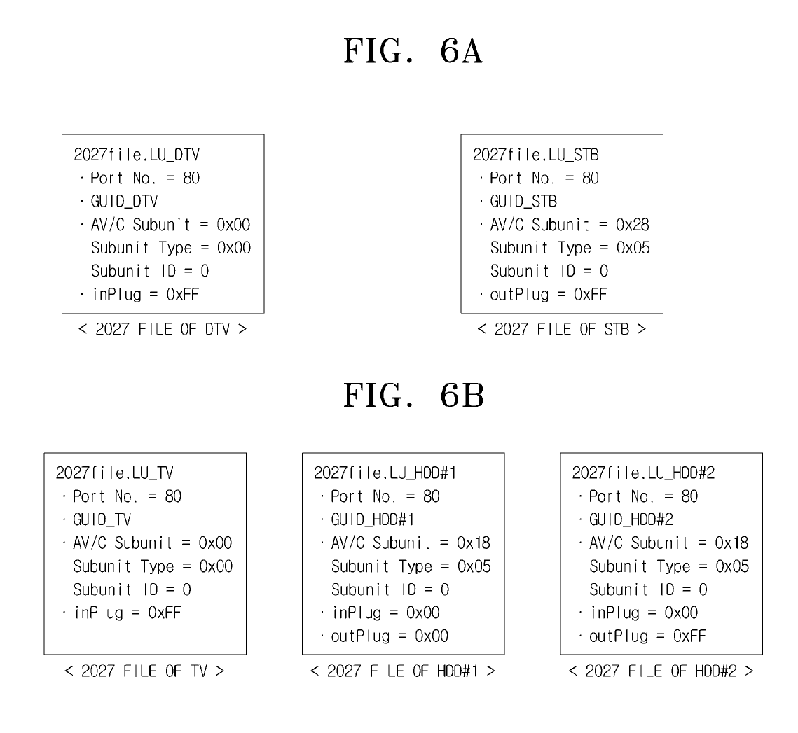

From the second attribute information provided by the second bridge apparatus 200 as shown in FIG. 6B, the first controller 150 acquires the presence of the TV and the storage media as the logical units (LUs) in the second cluster 20, an available port, GUIDs, plugs, and services provided by the second devices 21, 22 and 23.

The first controller 150 generates modified second attribute information by changing the second attribute information corresponding to the TV 21, the second attribute information corresponding to the first storage medium 22, and the second attribute information corresponding to the second storage medium 23, and creates a plurality of LUs corresponding to second virtual devices corresponding to the TV 21, the first storage medium 22, and the second storage medium 23, that is, corresponding to the virtual TV, the first virtual storage medium, and the second virtual storage medium. In other words, the first controller 150 creates the second virtual devices, that is, LUs in the first bridge apparatus 100 as shown in FIG. 7A by adding the modified second attribute information to the 2027 file provided from a HANA application of the first controller 150, generates and stores a first routing table as shown in FIG. 7B using the second attribute information and the modified second attribute information.

To make the first devices 11 and 12 recognize as if the second virtual devices exist in the first cluster 10 in reality, the first controller 150 provides a 2027 file where the second virtual devices are created to the first devices 11 and 12.

The first controller 150 controls the first internal communicator 110 to notify the change with respect to the second virtual devices. Accordingly, the first devices 11 and 12 recognize as if these services are provided directly from the first controller 150, and the first controller 150 acts as a proxy for the second devices 21, 22 and 23 of the second cluster 20.

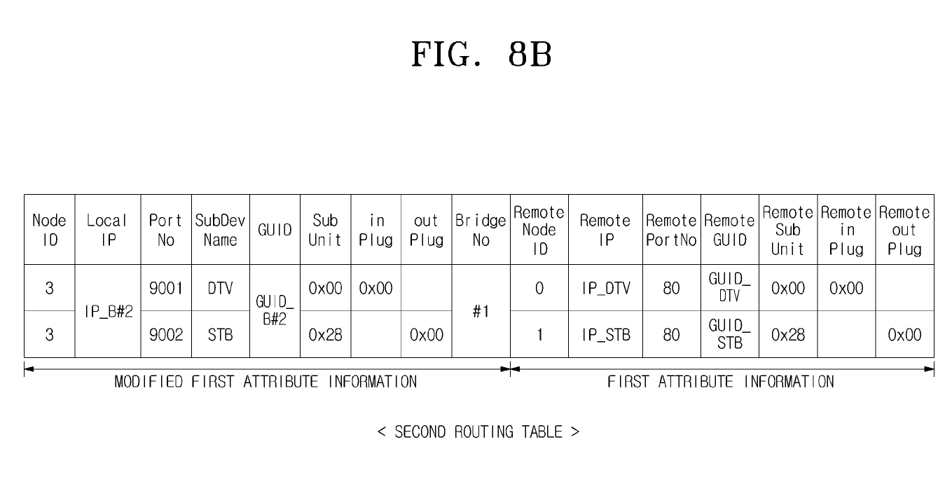

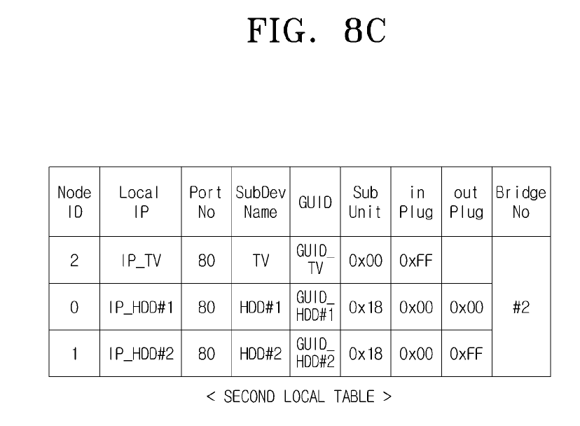

From the first attribute information provided from the first bridge apparatus 100 as shown in FIG. 6A, the second controller 250 acquires the presence of the DTV and the STB as the LUs in the first cluster 10, an available port, GUIDs, plugs, and services provided by the first devices 11 and 12. The second controller 250 generates modified first attribute information by changing the provided first attribute information, creates first virtual devices corresponding to the DTV 11 and the STB 12, that is, the virtual DTV and the virtual STB by adding the virtual devices to a 2027 file provided by a HANA application of the second controller 250 as shown in FIG. 8A, generates and stores a second routing table as shown in FIG. 8B using the first attribute information and the modified first attribute information.

To make the second devices 21, 22 and 23 recognize as if the first virtual devices exist in the second cluster 20 in reality, the second controller 250 provides a 2027 file including the first virtual devices, that is, the 2027 file as shown in FIG. 8A to the second devices 21, 22 and 23.

Thus, the second devices 21, 22 and 23 recognize as if these services are provided directly from the second controller 250, and the second controller 250 acts as a proxy for the first devices 11 and 12.

Therefore, the first bridge apparatus 100 detects services provided from the second cluster 20 and acts as a proxy, and the user can request a service provided from the second cluster 20 through the first devices 11 and 12.

When the user requests the service provided from the second virtual device using the first devices 11 and 12, the first controller 150 notifies the second cluster 20 of the connection request with the second devices 21, 22 and 23 corresponding to the virtual devices using the stored first routing table. That is, the first controller 150 controls the first external communicator 140 to route to the second bridge apparatus 200 using the first routing table.

Upon receiving the connection request with the second devices 21, 22 and 23 through the second external communicator 240 of the second bridge apparatus 200, the second controller 250 confirms the virtual devices, which request the connection, corresponding to the first devices 11 and 12, from the second routing table. The second controller 250 establishes the connection with the second devices 21, 22 and 23 by referring to the plugs of the second devices 21, 22 and 23 of which the connection is requested, and receives transport streams from the second devices 21, 22 and 23.

In doing so, since the second bridge apparatus 200 acts as a proxy for the first devices 11 and 12, the second devices 21, 22 and 23 recognize that the second bridge apparatus 200 requests the connection, and thus transmits the transport streams to the second bridge apparatus 200 through the output plugs assigned to the second devices 21, 22 and 23. The second controller 250 receives the transport streams from the second devices 21, 22 and 23 through the input plugs of the virtual devices corresponding to the first devices 11 and 12 confirmed from the second routing table. Next, the second controller 250 controls the second external communicator 240 to forward the received transport streams to the first bridge apparatus 100.

Upon receiving the transport streams from the second bridge apparatus 200, the first controller 150 controls the first internal communicator 110 to provide the transport streams to the first devices 11 and 12 through the changed output plugs of the modified second attribute information of the second devices 21, 22 and 23 which provide the transport streams. This is because the first controller 150 is acting as a proxy for the second devices 21, 22 and 23. The first devices 11 and 12, which requested the connection from the second devices 21, 22 and 23, receive, process, and display the transport streams on a screen.

FIG. 6A depicts the first attribute information of the first device of FIG. 1, and FIG. 6B depicts the second attribute information of the second device.

In the 2027 file of the DTV 11 of FIG. 6A, the port number ‘80’ for the IP communication, the GUID ‘GUID_DTV’, the AV/C subunit ‘0x00’, and the input plug (in Plug) ‘0xFF’ are defined. In the 2027 file of the STB 12, the port number ‘80’ for the IP communication, the GUID ‘GUID_STB’, the AV/C subunit ‘0x28’, and the output plug (outPlug) ‘0xFF’ are defined as the first attribute information.

Each of the first devices (e.g., the DTV 11) has 32 plugs, that is, the input plugs no. 0-31 and/or the output plugs no. 0-31. This is because the first devices 11 and 12 can transmit and receive transport streams to and from one or more devices at the same time. For instance, the STB 12 can provide a transport stream to both the DTV 11 and the TV 21 of the second cluster 20 at the same time. In this case, the STB 12 requires two output plugs.

One or more input plugs or output plugs can be forcibly allocated from no. 0-31 by a designer or programming, or dynamically allocated to a temporary plug ‘0xFF’. For instance, the input plug ‘0xFF’ allocated as shown in FIG. 6A denotes that an idle plug of the plugs no. 0-30 is available. When using the temporary plug, a service can be provided more smoothly and fast than using the fixed input plug.

In the 2027 file of the TV 21 in FIG. 6B, a port number ‘80’ for IP communication, a GUID ‘GUID_TV’, an AV/C subunit ‘0x00’ and an input plug ‘0xFF’ are defined as attribute information.

In the 2027 file of the first storage medium 22, the port number ‘80’ for IP communication, a GUID ‘GUID_HDD#1’, an AV/C subunit ‘0x18’, an input plug ‘0x00’, and an output plug ‘0x00’ are defined as attribute information.

In the 2027 file of the second storage medium 23, a port number ‘80’ for IP communication, a GUID ‘GUID_HDD#2’, an AV/C subunit ‘0x18’, an input plug ‘0x00’, and an output plug ‘0xFF’ are defined as attribute information. In FIGS. 6A and 6B, the input plug number and the output plug number can be set to a fixed number or to ‘0xFF’ in the designing phase.

FIG. 7A illustrates the modified second attribute information generated by the first controller of FIG. 3.

Referring to FIGS. 6B and 7A, the first controller 150 generates the modified second attribute information by altering the GUID, the input plug, the output plug, and the port number of the second attribute information. In doing so, the first controller 150 assigns the same GUID to all of the second devices 21, 22 and 23 and different port numbers and different plugs to them. The same GUID is assigned because the virtual devices are created in the first bridge apparatus 100 alone.

For instance, the GUID of the virtual TV corresponding to the TV 21 is changed from ‘GUID_TV’ to ‘GUID_B#1’, and the port number is changed from ‘80’ to ‘8001’. The input plug ‘0x00’ is not changed because the plug corresponding to ‘0x00’ among the input plugs no. 0-30 assigned to the first bridge apparatus 100 is not yet assigned to the another device.

The GUID of the first virtual storage medium corresponding to the first storage medium 22 is changed from ‘GUID_HDD#1’ to ‘GUID_B#1’, the port number is changed from ‘80’ to ‘8002’, the input plug is changed from ‘0x00’ to ‘0x01’, and the output plus is not changed. Since ‘0x00’ of the input plugs no. 0-30 assigned to the first bridge apparatus 100 is assigned to the virtual TV already, the first controller 150 assigns the first virtual storage medium another input plug not assigned. The output plus is not changed because the output plug ‘0x00’ of the first bridge apparatus 100 is not assigned yet.

As such, when the modified second attribute information is added to the 2027 file of the first controller 150, a new 2027 file is generated as shown in FIG. 7A. The first controller 150 generates the first routing table as shown in FIG. 7B using the second attribute information and the modified second attribute information. The new 2027 file including the first attribute information of FIG. 6A and the modified second attribute information, and the first routing table are stored to the first storage 120.

In FIG. 5, when the first controller 150 generates the new 2027 file with the modified second attribute information, the format text representing one device as indicated by ‘A’ is added to the 2027 file for each virtual device. That is, one 2027 file includes a plurality of LUs.

When one of the first devices 11 and 12 requests a service of a virtual device, the first routing table is used for the first controller 150 to request the service from the second cluster 20. As the first bridge apparatus 100 is a physically single entity, the same local IP and GUID are assigned to the virtual devices in FIG. 7B.

FIG. 8A depicts the modified first attribute information generated by the second controller of FIG. 3, and FIG. 8B depicts the second routing table generated by the second controller with the modified first attribute information.

Referring to FIGS. 8A and 8B, the second bridge apparatus 200 generates a 2027 file including the modified first attribute information and the second routing table in the similar way as in FIGS. 7A and 7B, and further description shall be omitted. The new 2027 file including the second attribute information of FIG. 6B and the modified first attribute information, and the generated second routing table are stored to the second storage 220.

When the first and second routing tables are generated as shown in FIGS. 7B and 8B, the first controller 150 and the second controller 250 control the first internal communicator 110 and the second internal communicator 210 to reset the buses. Hence, the 1394 initialization is re-performed and an IP address is re-allocated to every device having an installed HANA application.

Next, the first controller 150 controls the first internal communicator 110 to transmit a 2027 file including modified second attribute information of FIG. 7A to the first devices 11 and 12, and the first devices 11 and 12 provide first attribute information of FIG. 6A to the first internal communicator 110. The first controller 150 generates a first local table of FIG. 7C using the first attribute information of FIG. 6A provided from the first devices 11 and 12. Herein, the ‘local’ denotes the information relating to the device positioned in the same cluster as the first controller 150. The first controller 150 controls to store the new 2027 file of FIG. 7A, the first routing table of FIG. 7B, and the first local table of FIG. 7C to the first storage 120.

The second controller 250 controls the second internal communicator 210 to transmit a 2027 file including modified first attribute information of FIG. 8A to the second devices 21, 22 and 23. The second devices 21, 22 and 23 provide second attribute information of FIG. 6B to the second internal communicator 210. The second controller 250 generates a second local table as shown in FIG. 8C using the second attribute information of FIG. 6B. The second controller 250 controls to store the new 2027 file of FIG. 8A, the second routing table of FIG. 8B, and the second local table of FIG. 8C to the second storage 220.

The first devices 11 and 12 store the 2027 file including the modified second attribute information as shown in FIG. 7A, and the second devices 21, 22 and 23 store the 2027 file including the modified first attribute information as shown in FIG. 8A. Accordingly, the first devices 11 and 12 recognize as if the first bridge apparatus 100 is the second devices 21, 22 and 23, and as if the first bridge apparatus 100 provides the services of the second devices 21, 22 and 23. The second devices 21, 22 and 23 recognize as if the second bridge apparatus 200 is the first devices 11 and 12, and as if the second bridge apparatus 200 provides the services of the first devices 11 and 12.

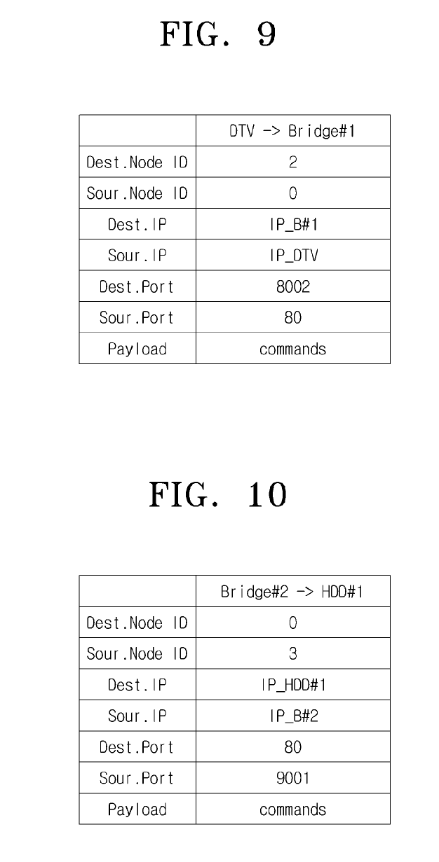

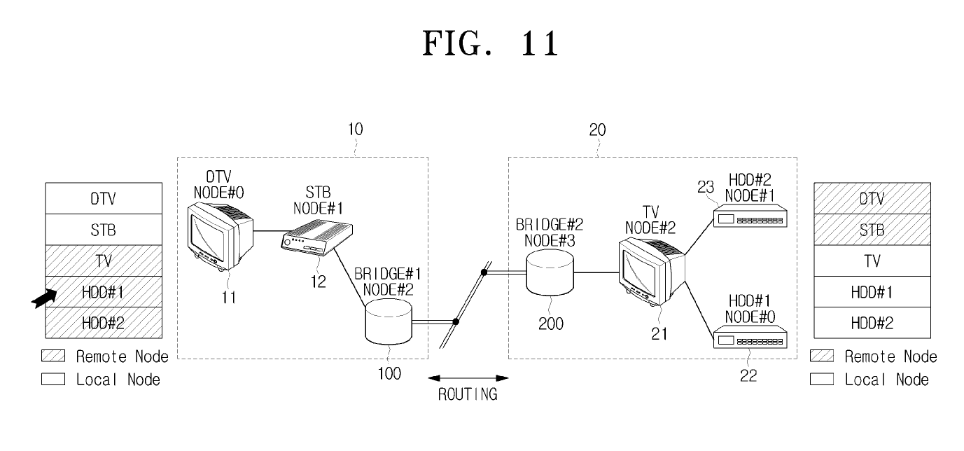

FIG. 9 is a table of information used for the DTV 11 to request transmission of an icon from the first bridge apparatus 100, and FIG. 10 is a table of information used for the second bridge apparatus 200 to request icon transmission from the first storage medium 22.

To perform an HTTP communication with the first storage medium 22 of the second cluster, the DTV 11 uses the HTTP communication port no. ‘8002’ by referring to the 2027 information of FIG. 7A provided from the first bridge apparatus 100. Since the first bridge apparatus 100 is the proxy for the first storage medium 22 of the second cluster, the HTTP communication is executed based on the 2027 information of FIG. 7A.

Referring to FIGS. 7B and 9, the DTV 11 recognizes that the newly connected device, that is, the destination to be set is the first bridge apparatus 100, and uses ‘2’ as ‘Dest.Node ID’ and ‘8002’ as ‘Dest.Port’. The packet header generated by referring to FIG. 9 is ‘Dest.IP’ which has an IP address of the first bridge apparatus 100 rather than the first storage medium 22, and has commands of ‘ICON.JPG’.

After confirming the HTTP communication port no. ‘8002’, the first controller 150 recognizes that the service request received from the DTV 11 needs to be forwarded to the first storage medium 22 of the second cluster 20 by referring to FIG. 7B. The first bridge apparatus 100 forwards the service request received from the DTV 11 to the second bridge apparatus 200.

In more detail, the first controller 150 controls the first external communicator 140 to confirm that the device mapped to 8002 in the first routing table is the first storage medium 22, and to confirm the port 80 actually allocated to the first storage medium 22. The first controller 150 notifies the second bridge apparatus 200 of the icon transmission request from the second storage medium 22 by the DTV 11 using the IP address assigned to the first bridge apparatus 100.

Upon receiving the packet from the first bridge apparatus 100, the second controller 250 of the second bridge apparatus 200 checks the source (the DTV 11 requesting the transport stream) and the destination (the first storage medium 22 providing the transport stream) from the header of the received packet. After confirming the source and the destination, the second controller 250 confirms the presence of the virtual DTV corresponding to the DTV 11 from the second routing table.

The second controller 250 modifies the header of the packet to be sent to the first storage medium 22 based on the second routing table stored to the second storage 220, and transmits the modified packet to the first storage medium 22. Thus, the second bridge apparatus 200 acts as the proxy for the DTV 11 and finishes the HTTP communication relay (hereinafter ‘HTTP relay’). Specifically, the second controller 250 changes ‘Sour.IP’ from ‘IP_DTV’ to ‘IP_B#2’, changes ‘Sour.Port’ from ‘80’ to ‘9001’, and changes the input plug from ‘0xFF’ to ‘0x00’ in the packet header destined for the first storage medium 22 as shown in FIG. 10. The packet header is modified because the second bridge apparatus 200 acts like the DTV 11. At this time, the routing in the HTTP relay is carried out based on the port number. The routing in the HTTP relay may be carried out based on a virtual host domain name.

The second controller 250 controls the second internal communicator 210 to transmit the packet having the header of the changed IP address to the first storage medium 22. To act as the proxy for the DTV 11, the second controller 250 informs the first storage medium 22 of the icon transmission request of the virtual DTV. The first storage medium 22 confirms the port ‘9001’ of the virtual DTV by referring to the 2027 file of the created virtual devices as shown in FIG. 8A, and then provides its icon file of first storage medium 22 to the second internal communicator 210.

The second controller 250 confirms the port ‘80’ of the DTV 11 and transmits the icon image to the first bridge apparatus 100 using the HTTP relay. The first controller 150 of the first bridge apparatus 100 recognizes the transmission of the icon requested by the DTV 11 and controls the first internal communicator 110 to transmit the icon image to the DTV 11. Hence, the DTV 11 displays the icon of the first storage medium 22 on its screen, and the icon display using the HTTP relay is finished.

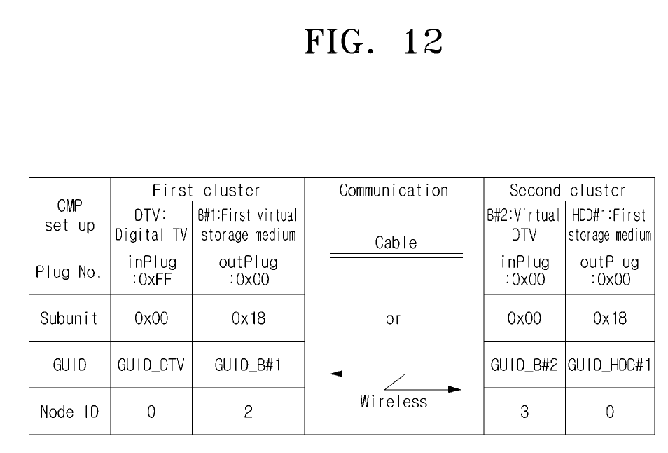

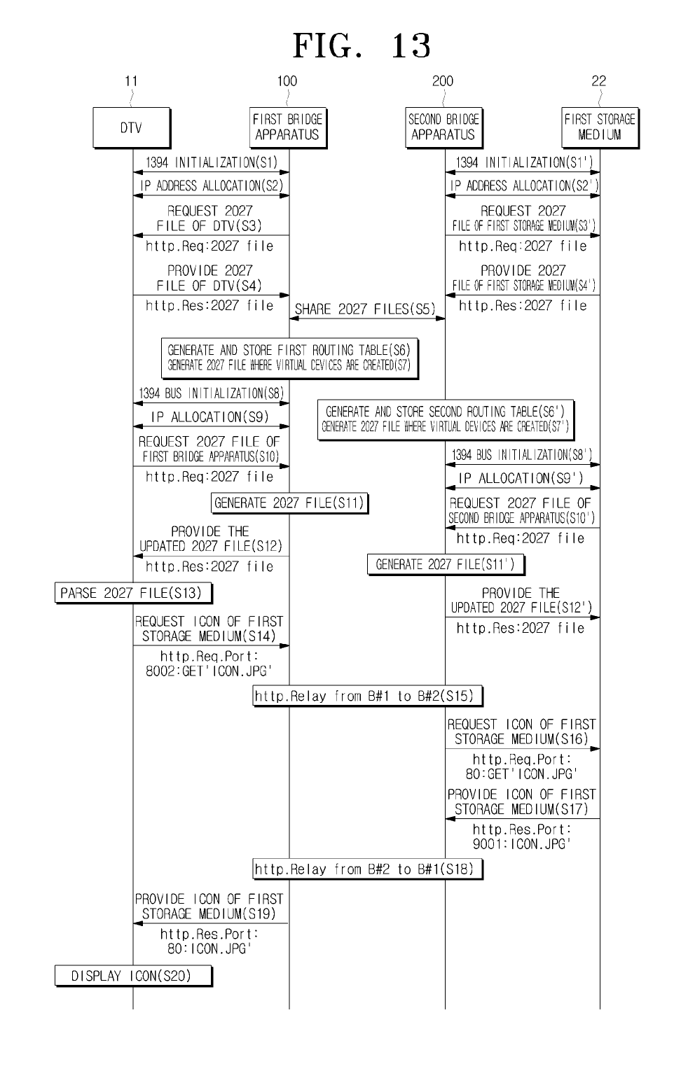

FIG. 11 illustrates an actual service request after icons of the second devices are displayed on the DTV 11, and FIG. 12 is a simplified table of information used for the DTV 11 to request a transport stream from the first storage medium and to receive the transport stream from the first storage medium.

Referring to FIGS. 11 and 12, the DTV 11 and the STB 12 recognize the TV 21, the first storage medium 22, and the second storage medium 23 as if these second devices are actually present in the first cluster 10 besides the DTV 11 and the STB 12.

The DTV 11 and the STB 12 in FIG. 11 represent local nodes, that is, local devices in the first cluster 10. The TV 21, HDD#1 22, HDD#2 23 represent remote nodes in the first cluster 10, that is, virtual devices corresponding to the second devices 21, 22 and 23. Also, the DTV 11 and the STB 12 represent remote nodes in the second cluster 20, that is, virtual devices corresponding to the first devices 11 and 12. The TV 21, the HDD#1 22, and the HDD#2 23 represent local nodes in the second cluster 20, that is, local devices.

For instance, the display of the DTV 11 shows the icons of the STB 12, the TV 21, the first storage medium 22, and the second storage medium 23. When a user requests a service of one of the displayed icons, for example, when the user requests to reproduce a video stored to the first storage medium 22, the DTV 11 establishes a Communication Management Procedure (CMP), that is, an isochronous stream connection with the first bridge apparatus 100, and requests a connection with the first storage medium 22 through the first internal communicator 110 (for further information about 1394 CMP, see IEC-61883-1 (2003-01), Consumer audio/video equipment—Digital interface—Part 1: General). The port number is used in the HTTP relay, whereas the service is provided using the plug in the CMP.

In further detail, recognizing the first bridge apparatus 100 as the first storage medium 22, the DTV 11 generates a packet to request a transport stream transmission from the first bridge apparatus 100 by referring to the modified second attribute information of FIG. 7A. For doing so, the DTV 11 performs a 1394 CMP with the corresponding output plug number by referring to the output plug information included in the modified second attribute information of FIG. 7A provided from the first bridge apparatus 100. When the 1394 CMP between the DTV 11 and the first bridge apparatus 100 succeeds, the first controller 150 controls the first external communicator 140 to perform the 1394 CMP relay to inform the second bridge apparatus 200 of the connection request with the first storage medium 22 using the first attribute information and the first routing table of the DTV 11 stored to the first storage 120.

When confirming the reception of the connection request with the first storage medium 22 from the DTV 11 through the 1394 CMP relay, the second bridge apparatus 200 serves as a proxy for the DTV 11, and acts as if it is the DTV 11. The second controller 250 confirms the modified first attribute information of the virtual DTV corresponding to the DTV 11 from the second routing table.

The second bridge apparatus 200 performs the 1394 CMP by referring to the output plug information of the first storage medium 22. When the 1394 CMP between the second bridge apparatus 200 and the first storage medium 22 succeeds, the first storage medium 22 transmits the transport stream to the virtual DTV of the second bridge apparatus 200 through the output plug ‘0x00’. The second bridge apparatus 200 receives the transport stream through the input plug ‘0x00’ of the virtual DTV. Next, the second bridge apparatus 200 controls the second external communicator 240 to forward the transport stream to the first bridge apparatus 100. The first bridge apparatus 100 relays the transport stream received through the first external communicator 140 to the first cluster 10 where the DTV 11 is positioned.

An isochronous channel number and the input/output plug information defined in the 1394 CMP between the DTV 11 and the first bridge apparatus 100 and between the second bridge apparatus 200 and the first storage medium 22 are used as primary parameters for the transport stream relay function between the first and second bridge apparatuses 100 and 200. As a result, the transport stream received from the first storage medium 22 is output on the screen of the DTV 11.

FIG. 13 illustrates operations before an actual transport stream is transmitted and received in communication over the 1394 network of FIG. 1.

The first cluster 10 includes the first devices 11 and 12, and the second cluster 20 includes the second devices 21, 22 and 23. To ease the understanding of the present invention, the DTV 11 of the devices 11 and 12, and the first storage medium 22 of the second devices 21, 22 and 23 are illustrated by way of example.

Referring to FIGS. 1, 3 and 13, when power is supplied to, a new devices is connected to, or the existing device is deleted from the first cluster 10 and the second cluster 20, the first internal communicator 110 and the second internal communicator 210 perform a 1394 initialization (S1 and S1′).

The DTV 11 having an installed HANA application, the first bridge apparatus 100, the second bridge apparatus 200, and the first storage medium 22 are assigned respective IP addresses (S2 and S2′).

When the IP addresses are assigned, the first bridge apparatus 100 performs a local node discovery to search for local units, that is, the first devices 11 and 12 in the first cluster 10. In specific, the first controller 150 of the first bridge apparatus 100 controls the first internal communicator 110 to request transmission of a 2027 file of the DTV 11 from the DTV 11 using a message such as ‘Http.Req:2027 file’ (S3).

According to the request of the first bridge apparatus 100, the DTV 11 provides a pre-stored 2027 file to the first bridge apparatus 100 using a command such as ‘Http.Res:2027 file’ (S4). Herein, the 2027 file is constituted as shown in FIG. 6A and delivers first attribute information provided by the DTV 11 for communication.

The second controller 250 of the second bridge apparatus 200 controls the second internal communicator 210 to request transmission of a 2027 file of the first storage medium 22 from the first storage medium 22 (S3′). The first storage medium 22 provides the 2027 file of FIG. 6B to the second bridge apparatus 200 (S4′). The 2027 file of FIG. 6B carries second attribute information provided from the first storage medium 22 for communication.

The first bridge apparatus 100 and the second bridge apparatus 200 share the 2027 file of the DTV 11 and the 2027 file of the first storage medium 22 (S5).

Hence, the first controller 150 creates a first virtual storage medium corresponding to the first storage medium 22 by changing the 2027 file of the first storage medium 22 belonging to the second cluster 20, that is, by changing the second attribute information. The first controller 150 stores in the first storage 120 the second attribute information and the modified second attribute information which is changed from the second attribute information, and generates and stores a first routing table (S6). The first controller 150 generates and stores a 2027 file including the first virtual storage medium (S7).

The second controller 250 performs operations S6′ and S7′ similar to operations S6 and S7.

After operations S7 and S7′, the first internal communicator 110 and the second internal communicator 210 perform an 1394 initialization (S8 and S8′). The DTV 11, the first bridge apparatus 100, the second bridge apparatus 200, and the first storage medium 22 are reassigned respective IP addresses (S9 and S9′).

When the IP addresses reassigned, the DTV 11 requests transmission of the 2027 file of the first bridge apparatus 100 from the first bridge apparatus 100 (S10). The first controller 150 reads the 2027 file from the first storage 120 and generates the read 2027 file into a transmittable format such as XML format (S11), and controls the first internal communicator 110 to transmit the updated 2027 file to the DTV 11 (S12).

The first storage medium 22 requests transmission of the 2027 file of the second bridge apparatus 200 from the second bridge apparatus (S10′). The second controller 250 reads the 2027 file stored in operation S7′ and generates the read 2027 file into a transmittable format such as XML format (S11′), and controls the second internal communicator 210 to transmit the updated file to the first storage medium 22 (S12′). The DTV 11 and the first storage medium 22 receive the updated 2027 files of the first and second bridge apparatuses 100 and 200, respectively. The second controller 250 recognizes a service provided from the DTV 11.

Now, descriptions explain that the DTV 11 of the first cluster 10 requests generation of an icon and a CMP.

After operation S12, the DTV 11 parses the updated 2057 file received in operation S12 (S13) and thus recognizes that the first bridge apparatus 100 additionally serves as the TV 21 and the first storage medium 22 such as HDD. This is because the 2027 file provided by the first bridge apparatus 100 contains the second attribute information of the first storage medium 22, and accordingly, the first bridge apparatus 100 acts as a proxy for the first storage medium 22. That is, in operation S13, the DTV 11 recognizes that a service provided from the storage medium is added.

When there is no icon of the first virtual storage medium installed to the first bridge apparatus 100, the DTV 11 requests transmission of the icon of the first virtual storage medium from the first bridge apparatus 100 (S14). In doing so, the DTV 11 transmits a packet requesting the icon by recording the port number ‘8002’ of the first virtual storage medium corresponding to the first storage medium 22 into a command such as ‘GET’ICON.JPG′.

The first controller 150 confirms the presence of the first storage medium 22 in the second cluster 20 using ‘Dest.Port: 8002’ of the stored first routing table, and performs an HTTP relay (S15).

Upon receiving the packet from the first bridge apparatus 100, the second controller 250 of the second bridge apparatus 200 confirms the presence of the virtual DTV corresponding to the DTV 11 from the second routing table, and informs of the icon transmission request by sending a packet indicative of ‘HTTP.Req.Port:80:GET’ICON.JPG″ to the first storage medium 22 (S16).

The first storage medium 22 confirms the port ‘9001’ of the virtual DTV by referring to the 2027 file including the modified first attribute information showing the virtual DTV as shown in FIG. 8A, and provides the icon of the first storage medium 22 to the second internal communicator 210 using a packet indicative of ‘HTTP.Res.Port:9001’ICON.JPG″ (S17).

The second controller 250 confirms the port ‘80’ of the DTV 11 mapped to the port ‘9001’ in the command ‘HTT.Res.Port:9001’ICON.JPG″, and transmits the icon to the first bridge apparatus 100 through the HTTP relay (S18).

The controller 150 of the first bridge apparatus 100 recognizes the icon transmission requested by the DTV 11 and controls the first internal communicator 110 to forward the icon to the DTV 11 using a command ‘HTTP.Res.Port.:80’ICON.JPG″ (S19). Thus, the DTV 11 displays the icon of the first storage medium 22 on its screen (S20). The icon reception in operation S14 through S20 are merely an example of an HTTP relay and not limited to the icon.

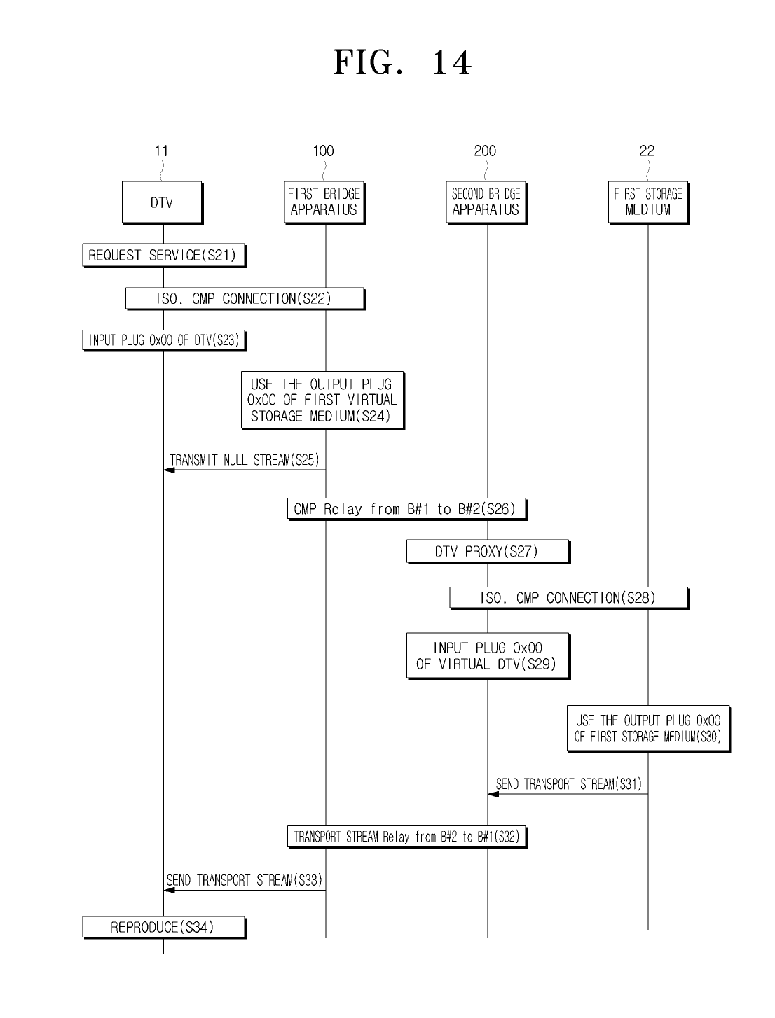

FIG. 14 illustrates reception of a transport stream at the DTV of the first cluster 10 from the first storage medium 22 of the second cluster 20 after the operations of FIG. 13 are carried out.

After operation S20 in FIG. 13, the user can request a service provided by the first cluster 10 or the second cluster 20 (S21). For instance, as the DTV 11 displays the icon of the first storage medium 22 on the screen, the user can request a service provided by the first storage medium 22. When the user requests a service such as reproduction of a transport stream in step S21, the first cluster 10 performs International Organization for Standardization (ISO).1394 CMP connection (S22).

After operation S22, the DTV 11 changes its input plug ‘0xFF’ to an idle plug, e.g., to a plug ‘0x00’ of plugs no. 0-30 (S23). Accordingly, the first virtual storage medium 22 uses an output plug ‘0x00’ (S24).

After operation S24, the first controller 150 controls the first internal communicator 110 to transmit a null stream to the DTV 11 through the output plug ‘0x00’ (S25) and controls the first external communicator 140 to perform a CMP relay using the first attribute information and the first routing table stored to the first storage 120 (S26).

After operation S26, when receiving a request for a connection with the first storage medium 22 from the DTV 11, the second bridge apparatus 200 acts as if it is the DTV 11 by acting as a proxy for the DTV 11 (S27).

Next, the second cluster 10 performs an ISO.1394 CMP connection (S28).

The second controller 250 lets the input plug ‘0x00’ of the virtual DTV stand by (S29).

The first storage medium 22 transmits the transport stream to the virtual DTV of the second bridge apparatus 200 using the output plug ‘0x00’ (S30 and S31).

The second bridge apparatus 200, which acts as the proxy for the DTV 11, receives the transport stream through the input plug ‘0x00’ of the virtual DTV. The second bridge apparatus 200 controls the second external communicator 240 to relay the transport stream to the first bridge apparatus 100 (S32).

Upon receiving the transport stream from the second bridge apparatus 200, the first controller 150 controls the first internal communicator 110 to forward the transport stream to the DTV 11 through the output plug ‘0x00’ of the first virtual storage medium corresponding to the first storage medium 22 (S33). The DTV 11 receives the transport stream through the changed input plug ‘0x01’, processes and displays the received transport stream on the screen (S34).

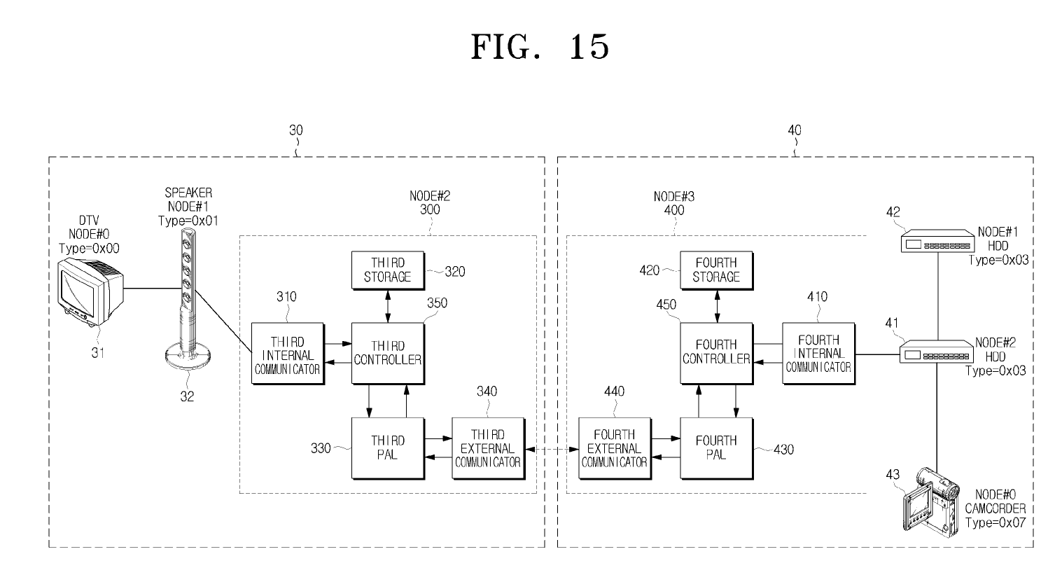

FIG. 15 illustrates a 1394 network to which a network bridge apparatus is applied according to further exemplary embodiment of the present invention.

The 1394 network of FIG. 15 includes a third cluster 30 and a fourth cluster 40. The third cluster 30 is a network group established by connecting a plurality of third devices 31 and 32 using a third bridge apparatus 300. The fourth cluster 400 is a network group established by connecting a plurality of fourth devices 41, 42 and 43 using a fourth bridge apparatus 400.

The third bridge apparatus 300 includes a third internal communicator 310, a third storage 320, a third PAL 330, a third external communicator 340, and a third controller 350. The fourth bridge apparatus 400 includes a fourth internal communicator 410, a fourth storage 420, a fourth PAL 430, a fourth external communicator 440, and a fourth controller 450. The third cluster 30, the fourth cluster 40, the third bridge apparatus 300, the fourth bridge apparatus 400, the third devices 31 and 32, and the fourth devices 41, 42 and 43 of FIG. 15 are similar to the first cluster 10, the second cluster 20, the first devices 11 and 12, the second devices 21, 22 and 23, the first bridge apparatus 100, and the second bridge apparatus 200 of FIGS. 1 and 3, and thus their detailed explanation shall be omitted.

Yet, the third bridge apparatus 300, the fourth bridge apparatus 400, the third devices 31 and 32, and the fourth devices 41, 42 and 43 of FIG. 15 are AV/C devices operating based on an AV/C application rather than a HANA application, and support a communication protocol of the 1394 standard.

In the following explanation, the third devices 31 and 32 are a DTV 31 and a speaker 32, and the fourth devices 41, 42 and 43 are a third storage medium 41 such as a HDD, a fourth storage medium 42, and a camcorder 43 by way of example.

Still referring to FIG. 15, the third devices 31 and 32, the fourth devices 41, 42 and 43, the third bridge apparatus 300, and the fourth bridge apparatus 400 use AV/C unit commands, and an addressing scheme of a subunit type and a subunit ID conforms to the AV/C specification (see 1394TA Document 2004006, AV/C Digital Interface Command Set General Specification, Version 4.2), and their detailed description shall be omitted.

An AV/C application for the AV/C specification provides subunit information and GUID information of an AV/C device, and the 1394 protocol provides plug information. Accordingly, the subunit information, the GUID information, and the plug information are stored to each AV/C device. The GUID, which is ID information of the device, can be the name of the device. The plug information is a logical plug number required for stream transmission. The subunit information includes the subunit type and the subunit ID.

A subunit indicates an AV/C device, and a subunit type indicates the type of an AV/C device. A subunit ID is an ID for distinguishing subunit types when there is a plurality of the same subunit types in one AV/C device. For instance, when one STB for cable broadcasting has two HDDs, the subunit types of the HDDs are identical but their subunit IDs are assigned ‘0’ and ‘1’, respectively.

When a new 1394 device is connected to the third cluster 30 or an existing 1394 device is deleted from the third cluster 30 or turned on, the third internal communicator 310 performs a 1394 initialization to allocate node IDs to the third devices 31 and 32 and the third bridge apparatus 300. Likewise, the fourth internal communicator 410 performs a 1394 initialization to allocate node IDs to the fourth devices 41, 42 and 43 and the fourth bridge apparatus 400.

As shown in FIG. 15, according to the 1394 initialization, NODE#0 is assigned to the DTV 31, NODE#1 is assigned to the speaker 32, NODE#2 is assigned to the third bridge apparatus 300, NODE#2 is assigned to the third storage medium 41, NODE#1 is assigned to the fourth storage medium 42, NODE#0 is assigned to the camcorder 43, and NODE#3 is assigned to the fourth bridge apparatus 400.

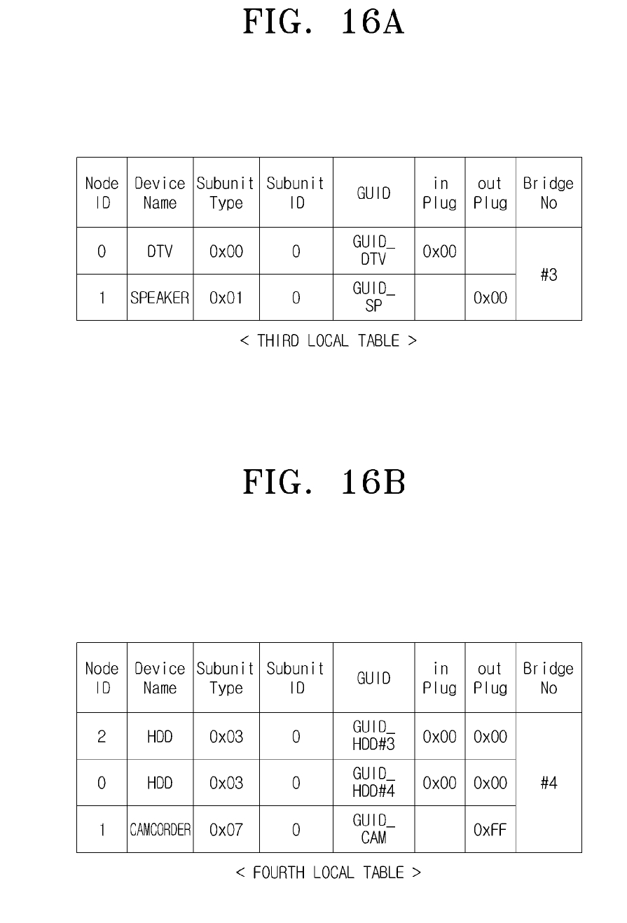

FIG. 16A shows a third local table generated by the third controller, and FIG. 16B shows a fourth local table generated by the fourth controller.

Referring to FIG. 16A, in a 1394 initialization phase, a memory of the DTV 31 holds third attribute information including a node ID ‘0’, a device name ‘DTV’, a subunit type ‘0x00’, a subunit ID ‘0’, a GUID ‘GUID_DTV’, an input plug ‘0x00’, and a bridge ‘#3’ indicative of connection to the third bridge apparatus 300. A memory (not shown) of the speaker 32 holds third attribute information similar to the third attribute information of the DTV 31. The third attribute information can be used for the DTV 31 and the speaker 32 to execute a 1394 communication or to communicate with the fourth devices of the fourth cluster 40.

Before the 1394 initialization is finished, the DTV 31 transmits its third attribute information to the speaker 32 and the third bridge apparatus 300, and the speaker 32 transmits its third attribute information to the DTV 31 and the third bridge apparatus 300. The third bridge apparatus 300 gathers the third attribute information provided from the DTV 31 and the speaker 32, generates the gathered information into the third local table of FIG. 16A, and stores the third local table to the third storage 320.

Likewise, the third storage medium 41, the fourth storage medium 42, and the camcorder 43 generate respective fourth attribute information including a GUID, subunit information and plug information in a 1394 initialization phase, and share the generated fourth attribute information with the fourth bridge apparatus 400. The fourth controller 450 generates the fourth local table of FIG. 16B with the fourth attribute information of the third storage medium 41, the fourth storage medium 42, and the camcorder 43, and stores the fourth local table to the fourth storage 420.

The third local table of FIG. 16A is stored to the DTV 31, the speaker 32, and the third storage medium 320. The fourth local table of FIG. 16B is stored to the third storage medium 41, the fourth storage medium 42, the camcorder 43, and the fourth storage 420.

When the third and fourth local tables are generated, the third controller 350 controls the third PAL 330 and the third external communicator 340 to transmit the third local table to the fourth bridge apparatus 400. The fourth controller 450 controls the fourth PAL 430 and the fourth external communicator 440 to transmit the fourth local table to the third bridge apparatus 300. Hence, the third bridge apparatus 300 and the fourth bridge apparatus 400 share the third local table and the fourth local table.

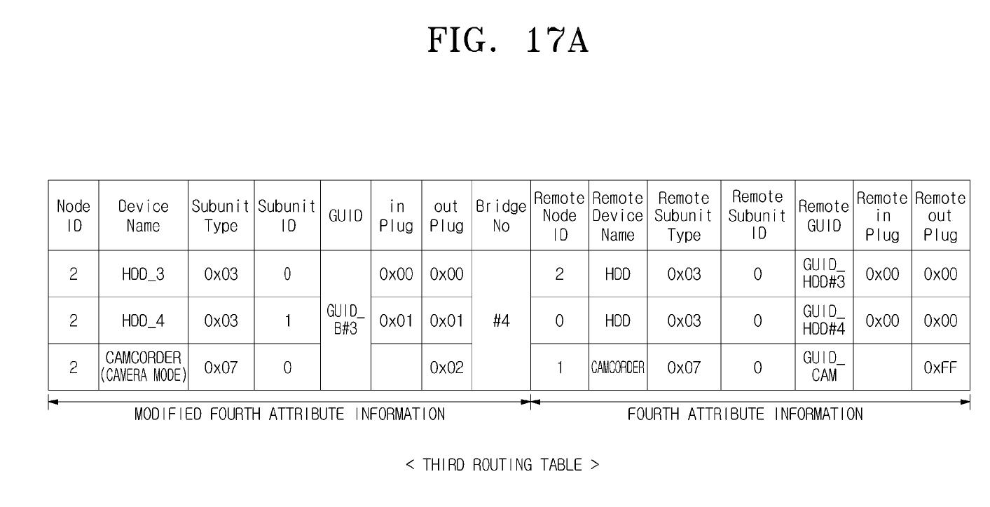

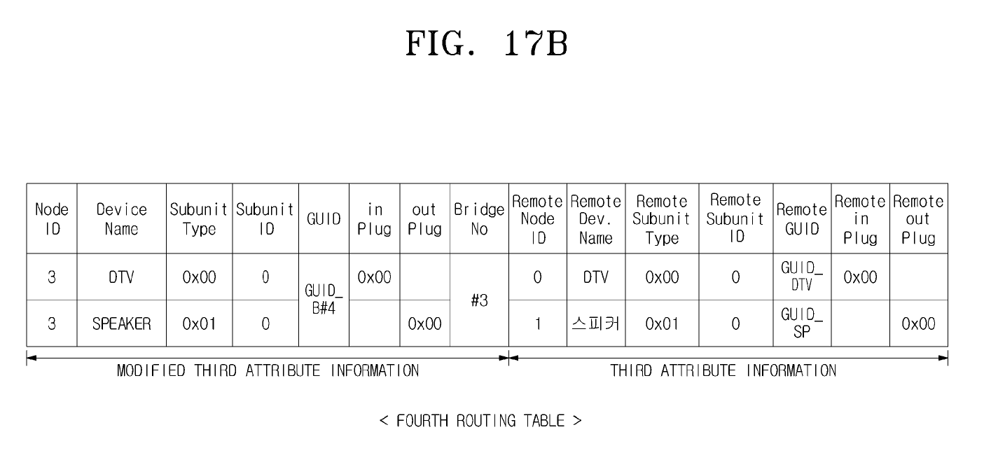

The third controller 350 generates modified fourth attribute information by changing the fourth attribute information in the fourth local table as shown in FIG. 17A, generates a third routing table using the fourth attribute information and the modified fourth attribute information, and stores the third routing table to the third storage 320. Referring to FIG. 17A, the third controller 350 changes the node IDs of the third storage medium 41, the fourth storage medium 42, and the camcorder 43 to ‘2’ and changes the subunit ID of the third storage medium 41 from ‘0’ to ‘1’. Also, the third controller 350 changes the input plug to ‘0x00-0x01’ in sequence and the output plugs to ‘0x00-0x02’ in sequence. Note that the input plugs and the output plugs are not necessarily assigned in sequence and that an idle plug can be assigned at random.

This is because the third bridge apparatus 300 is physically a single device and acts as a proxy for the third storage medium 41, the fourth storage medium 42, and the camcorder 43. In specific, the subunit ID is divided to ‘0’ and ‘1’ so that the third bridge apparatus 300 alone acts as the proxy for the two storage media 41 and 42. The input plug is not assigned to the camcorder 43 because the camcorder 43 is in a camera mode. The third controller 350 assigns different output plugs because the third bridge apparatus 300 alone acts as a proxy for the third storage medium 41, the fourth storage medium 42, and the camcorder 43 which are capable of outputting a transport stream.

The fourth controller 450 generates modified third attribute information as shown in FIG. 17B by changing the third attribute information of the third local table, generates a fourth routing table using the third attribute information and the modified third attribute information, and stores the fourth routing table to the fourth storage 420. As shown in FIG. 17B, the fourth controller 450 assigns a same node ID, GUID, and bridge number the DTV 31 and the speaker 32 to act as a proxy for the DTV 31 and the speaker 32. In general, since the DTV 31 receives a transport stream and the speaker 32 outputs sound to outside, the fourth controller 450 utilizes the input plug and the output plug without change.

When the third and fourth routing tables are generated as shown in FIGS. 17A and 17B, the third controller 350 controls the third internal communicator 310 to provide the third routing table to the DTV 31 and the speaker 32, and the fourth controller 450 controls the fourth internal communicator 410 to provide the fourth routing table to the third storage medium 41, the fourth storage medium 42, and the camcorder 43.

The DTV 31 and the speaker 32 store the received third routing table, and the third storage medium 41, the fourth storage medium 42, and the camcorder 43 store the received fourth routing table. Hence, the DTV 31 recognizes as if the third bridge apparatus 300 is the third storage medium 41, the fourth storage medium 42, and the camcorder 43. The third storage medium 41, the fourth storage medium 42, and the camcorder 43 recognize as if the fourth bridge apparatus 400 is the DTV 31 and the speaker 32. In other words, the third bridge apparatus 300 acts as a proxy for the third storage medium 41, the fourth storage medium 42, and the camcorder 43 of the fourth cluster 40. The fourth bridge apparatus 400 acts as a proxy for the DTV 31 and the speaker 32 of the third cluster 30.

For instance, when the DTV 31 of the third cluster 30 wants to get connected to and control the fourth storage medium 42 of the fourth cluster 40, the DTV 31 issues an AV/C unit command for controlling to the third bridge apparatus 300 which is a proxy for the fourth storage medium 42. As subunit information of the issued AV/C unit command, Subunit_type “0x03’ and Subunit_ID ‘1’ are used as shown in FIG. 17A. The third bridge apparatus 300 recognizes that the AV/C unit command needs to be forwarded to the fourth storage medium 42 of the fourth cluster, based on subunit addressing information (Subunit_type and Subunit_ID) of the DTV 31.

The third bridge apparatus 300 forwards the AV/C unit command of the DTV 31 to the fourth bridge apparatus 400 by referring to the third routing table of FIG. 17A. The fourth bridge apparatus 400 forwards the AV/C unit command received from the third bridge apparatus 300 to the fourth storage medium 42 of the fourth cluster 40 by referring to the fourth routing table of FIG. 17B. As a result, the AV/C unit command relay is completed.

To receive a transport stream from the fourth storage medium 42 of the fourth cluster 400 at the DTV 31 of the third cluster 300, a 1394 CMP relay should be carried out. The 1394 CMP relay is the same with or similar to the 1394 CMP relay of FIG. 1 and shall not be further illustrated.

While two clusters are illustrated in FIGS. 1 and 15 to ease the understanding, the actual application is not limited to two clusters. While each of the 2027 files of FIGS. 6A and 6B refers to only one LU in FIG. 1, the 1394 bridging is applicable to a plurality of LUs in the actual application. While each of the AV/C devices of FIG. 15 includes only one subunit, each of the AV/C devices may include a plurality of subunits. The 1394 bridging is feasible for an AV/C device including a plurality of subunits.

In FIG. 8B, the HTTP relay is routed based on a port number. A virtual host concept can be adopted together with the HTTP relay. The virtual host concept uses a domain name, instead of an IP address and a port number.

As set forth above, the network bridge apparatus and its communication method according to the exemplary embodiments of the present invention can provide a bridge function between the clusters using an existing 1394 chip. Specifically, the bridge function is provided by proxying for devices belonging to a foreign cluster using a 2027 file provided from a HANA application or plug and subunit information provided from an AV/C application. Therefore, a bridging function between clusters can be simply accomplished without having to separately fabricating a 1394 chip for the bridging function between the clusters.

Although a few exemplary embodiments of the present invention have been shown and described, it will be appreciated by those skilled in the art that changes may be made to these exemplary embodiments without departing from the principles and spirit of the invention, the scope of which is defined in the appended claims and their equivalents.

What is claimed is:

1. A network bridge apparatus comprising:
a storage which stores first attribute information which is provided by a first device of a first cluster for communication;
an external communicator which transmits the stored first attribute information to a second cluster and receives second attribute information which is provided by a second device of the second cluster for communication, from the second cluster; and
a controller which recognizes a service provided by the second device from the received second attribute information, creates a virtual device corresponding to the second device by changing the received second attribute information, and maps the changed second attribute information to the received second attribute information.

2. The network bridge apparatus of claim 1, wherein, when a service of the virtual device is requested by the first device, the controller informs the second cluster of a request for a connection to the second device corresponding to the virtual device using the changed second attribute information and the received second attribute information.

3. The network bridge apparatus of claim 1, wherein the controller notifies the creation of the virtual device to the first device, and
wherein the first device recognizes as if the virtual device exists in the first cluster.

4. The network bridge apparatus of claim 1, wherein the controller generates the changed second attribute information by changing a communication port number of the second device and a plug of the second device, required for transmitting a transport stream, included in the received second attribute information.

5. The network bridge apparatus of claim 4, wherein the first device, after requesting the connection with the virtual device, performs an Institute of Electrical and Electronics Engineers (IEEE) 1394 Communication Management Procedure (CMP) by referring to the changed plug information of the second device.

6. The network bridge apparatus of claim 5, further comprising an internal communicator which outputs the transport stream received from the second device to the first device through the changed plug of the second device.

7. The network bridge apparatus of claim 1, wherein the controller changes the received second attribute information to act as a proxy for the second device, and creates a virtual device corresponding to the changed second attribute information.

8. The network bridge apparatus of claim 2, wherein the second cluster comprises a bridge module which transmits the second attribute information to the external communicator, recognizes a service provided by the first device by receiving the first attribute information through the external communicator, creates a virtual device corresponding to the first device by changing the received first attribute information, and maps the changed first attribute information to the received first attribute information.

9. The network bridge apparatus of claim 8, wherein the bridge module performs an Institute of Electrical and Electronics Engineers (IEEE) 1394 Communication Management Procedure (CMP) by referring to plug information of the second device according to the request for a connection to the second device, receives a transport stream corresponding to the service requested by the first device and output from the second device through a plug of the second device, and forwards the received transport stream to the external communicator.

10. The network bridge apparatus of claim 9, wherein the bridge module receives the transport stream from the plug of the second device through a changed plug of the first device, wherein the changed plug is contained in the changed first attribute information.

11. The network bridge apparatus of claim 10, wherein the bridge module establishes the requested connection to the second device, and receives the transport stream by performing the IEEE 1394 CMP based on the plug information of the second device.

12. The network bridge apparatus of claim 11, wherein the bridge module changes the received first attribute information to act as the proxy for the first device, creates a virtual device corresponding to the changed first attribute information, and informs the second device of the virtual device creation.

13. The network bridge apparatus of claim 1, wherein each of the first and second devices comprises a plurality of plugs, and
wherein at least one of the plurality of plugs for transmitting and receiving a transport stream is a temporary plug which is set to use a plug currently not in an idle mode among the plurality of plugs.

14. The network bridge apparatus of claim 1, wherein a plurality of the first devices and a plurality of the second devices are connected to the network bridge apparatus.

15. The network bridge apparatus of claim 1, wherein the first cluster and the second cluster communicate with each other according to an Institute of Electrical and Electronics Engineers (IEEE) 1394 specification.

16. The network bridge apparatus of claim 15, wherein the first device, the second device, and the controller operate based on a High definition Audio-video Network Alliance (HANA) application, and
wherein the first device and the second device provide the first attribute information and the second attribute information, respectively, using a Consumer Electronics Association (CEA)-2027 file of the HANA application after an initialization phase according to the IEEE 1394 specification.

17. The network bridge apparatus of claim 16, wherein the second cluster gathers a CEA-2027 file of the second device comprising the second attribute information, from the second device, and transmits the gathered file to the external communicator, and
wherein the controller creates a virtual device corresponding to the second device by adding the second attribute information of the CEA-2027 file of the second device to a CEA-2027 file of the controller.

18. The network bridge apparatus of claim 15, wherein the first device, the second device, and the controller operate based on an Audio/Video Control (AV/C) application,
wherein the first cluster transmits the first attribute information to the second cluster in an initialization phase according to the IEEE 1394 specification, and
wherein the second cluster transmits the second attribute information to the external communicator in the initialization phase according to the IEEE 1394 specification.

19. The network bridge apparatus of claim 18, wherein each of the first attribute information and the second attribute information comprises subunit information comprising a subunit type and a subunit IDentifier (ID) for distinguishing the first device and the second device.

20. The network bridge apparatus of claim 1, wherein the first cluster and the second cluster communicate with each other using at least one of wired communication using a coaxial cable, wired communication using Power Line Communication (PLC), wired communication using an Ethernet cable, and wireless communication.

21. A communication method of a network bridge apparatus, the method comprising:
storing first attribute information which is provided by a first device of a first cluster for communication;
transmitting the stored first attribute information to a second cluster and receiving second attribute information which is provided by a second device of the second cluster for communication, from the second cluster;
recognizing a service of the second device from the received second attribute information, and creating a virtual device corresponding to the second device by changing the received second attribute information; and
mapping the changed second attribute information to the received second attribute information.

22. The communication method of claim 21, further comprising:
receiving a request of the first device for a service provided by the virtual device; and
informing the second cluster of a request for a connection to the second device corresponding to the virtual device using the changed second attribute information and the received second attribute information.

23. The communication method of claim 21 further comprising notifying the created virtual device creation to the first device, wherein the first device recognizes as if the virtual device exists in the first cluster.

24. The communication method of claim 21, wherein the creating the virtual device comprises generating the changed second attribute information by changing a communication port number of the second device and a plug of the second device, required for transmitting a transport stream, included in the received second attribute information.

25. The communication method of claim 24, wherein the first device performs an Institute of Electrical and Electronics Engineers (IEEE) 1394 Communication Management Procedure (CMP) based on the changed plug information of the second device after requesting the connection with the virtual device.
